(19) United States
(12) Patent Application Publication
(10) Pub. No.: US 2022/0127736 A1
(43) Pub. Date: Apr. 28, 2022

(54) Electrolyser for CO2 Reduction into Hydrocarbons

(71) Applicants: Paris Sciences et Lettres, Paris (FR); Centre National de la Recherche Scientifique (CNRS), Paris (FR); Sorbonne Universite, Paris (FR); College de France, Paris (FR)

(72) Inventors: Marc Fontecave, Saint Ismier (FR); Victor Mougel, Zurich (CH); Huan Tran Ngoc, Antony (FR); Daniel Alves Dalla Corte, Fontenay-sous-Bois (FR); Sarah Lamaison, Saint Jean-De-Luz (FR); Lukas Lutz, Schwäbisch Gmünd (DE)

(73) Assignees: Paris Sciences et Lettres - Quartier Latin, Paris (FR); College de France, Paris (FR); Centre National de la Recherche Scientifique (CNRS), Paris (FR); Sorbonne Universite, Paris (FR); College de France, Paris (FR)

(21) Appl. No.: 17/295,894

(22) PCT Filed: Nov. 21, 2019
(86) PCT No.: PCT/EP2019/082021

§ 371 Date: May 21, 2021

(30) Foreign Application Priority Data
Nov. 21, 2018 (EP) 18306541.6

(51) Int. Cl. C25B 11/077; C25B 3/03; C25B 3/26; C25B 11/061; C25B 9/15; C25B 15/08; C25B 9/65

(52) U.S. Cl. CPC C25B 11/077; C25B 3/03; C25B 3/26; C25B 9/65; C25B 9/15; C25B 15/08; C25B 11/061

(57) ABSTRACT

The present invention relates to an electrolysis device comprising an anode and a cathode, wherein the anode and the cathode each are an electrode comprising an electrically conductive support of which at least a part of the surface is covered by a metal deposit of copper, wherein the surface of the metal deposit is in an oxidized, sulfurated, selenated and/or tellurized form and the metal deposit has a specific surface area greater than or equal to 1 m²/g. The present invention relates also to a method for reducing CO₂ into hydrocarbons using an electrolysis device according to the invention. The method according to the invention comprises: a) providing an electrolysis device according to the invention; b) exposing the cathode of said electrolysis device to a CO₂-containing aqueous catholyte solution; c) exposing the anode of said electrolysis device to an aqueous anolyte solution; and d) applying an electrical current between the anode and the cathode in order to reduce the carbon dioxide into hydrocarbons.

### TECHNICAL FIELD

The present invention relates to an electrolyser in which both the anode and the cathode are a copper-based electrode, as well as a method for converting (i.e. reducing) CO₂ into hydrocarbons using such an electrolyser.

### BACKGROUND

Renewable energies (e.g. solar energy) suffer from intermittency issues due to i) their challenging connection to the electrical grid and ii) the volatility of the so-generated electricity price. To smooth the curve of electricity available on the grid for better fitting to the consumption curve and best valorize surplus production, storing electrical energy as chemical fuels thanks to an electrolyser is highly relevant. Thus conversion of carbon dioxide into hydrocarbons using renewable energy is an attractive strategy for storing such a renewable source of energy into the form of chemical energy (a fuel). In addition to the conversion of renewable electrical energy (or any other electrical energy) to fuels and thus for the production of renewable carbon-based products, such a conversion can be useful for valorizing industrial CO₂ waste and maximize profitability whilst vastly increasing the sustainability of the petrochemical industry.

In order to do so, it is not only the electrocatalysts but also their combination in a fully defined electrolysis cell (EC) that must be optimized. The electrocatalysts used on the anodic side where water oxidation occurs (also called Oxygen Evolution Reaction (OER)) and the cathodic side where carbon-based products are evolved must meet the three performance criteria which are i) high activity (high current density at low overpotential), ii) good stability and iii) selectivity.

2H₂O→O₂+4H⁺+4e⁻
Anodic side

xCO₂+(4x−2z−y)H⁺+(4x−2z−y)e⁻→CₓH_{y}O_{z}+(2x−z)H₂O
Cathodic side

A particular interest is given to systems able to prepare hydrocarbons, as CO₂ hence constitutes an alternative to fossil fuel-based chemical precursors. The full system then has to be further engineered to maximize the energy efficiency by i) minimizing the resistive losses and ii) enhance the product selectivity. The difficulty of designing an efficient electrocatalytic system is that the combination of the most efficient materials taken independently will not necessarily lead to the most efficient system as a whole.

To date, only very few functional systems for the electrochemical transformation of CO₂ have been reported. The most important factors to evaluate an electrolyzer for CO₂ reduction are its production of high added-value products, in particular hydrocarbons but also alcohols, with high energetic efficiency, and its low cost.

Two EC systems have been reported for the production of hydrocarbons and alcohols by CO₂ reduction (Yeo et al., ACS Sustainable Chem. Eng. 2017, 5, 9191-9199; Ager et al., Energy Environ. Sci., 2017, 10, 2222-2230). However, these systems use rare metals at the anode (iridium oxide) and thus are expensive, and they reach energy efficiencies of only 10.3% and 12.2%, respectively.

EC cells using earth-abundant catalysts (Fe and Co in Savéant et al., PNAS May 2, 2016. 201604628; Sn and Cu in Grätzel et al., Nat. Energy 2, 17087 (2017); ACS Catal 2016, 6, 3092) for electrochemical reduction of CO₂ at high current density have been described, but they afford only carbon monoxide as products which has a lower value than hydrocarbons or even alcohols.

Thus, there remains still a need for a low cost electrolyser for CO₂ reduction which is able to produce high added-value products, in particular hydrocarbons, with high energetic efficiency.

### SUMMARY OF THE INVENTION

Thus, the present invention relates to an electrolysis device comprising an anode and a cathode, wherein the anode and the cathode each are an electrode comprising an electrically conductive support of which at least a part of the surface is covered by a metal deposit of copper, wherein the surface of the metal deposit is in an oxidized, sulfurated, selenated and/or tellurized form and the metal deposit has a specific surface area greater than or equal to 1 m²/g.

The present invention relates also to a method for reducing CO₂ into hydrocarbons using an electrolysis device according to the invention. The method according to the invention comprises:

a) providing an electrolysis device according to the invention;
b) exposing the cathode of said electrolysis device to a CO₂-containing aqueous catholyte solution;
c) exposing the anode of said electrolysis device to an aqueous anolyte solution; and
d) applying an electrical current between the anode and the cathode in order to reduce the carbon dioxide into hydrocarbons.

The electrolysis device according to the invention allows the CO₂ reduction to hydrocarbons with a very low potential for hydrocarbon generation (2.95V at 25 mA/cm² vs. 4V at 25 mA/cm² for the best system known to date and described in Energy Environ. Sci. 2017, 10, 2222-2230).

Surprisingly, while it was thought that such a high efficiency required the use of rare metal electrodes (e.g. iridium oxide), it has been observed that the low-cost electrolysis device according to the invention in which the anode and the cathode each are an electrode comprising a copper oxide-based catalyst having a high specific surface area (copper being a very cheap and abundant metal) can allow unexpectedly high efficiencies. Thus said electrode comprising a copper oxide-based catalyst having a high specific surface area is effective for both Oxygen Evolution Reaction (OER) and CO₂ reduction into hydrocarbons. Moreover, the reduction of CO₂ is performed with a high selectivity for ethane and ethylene (also called ethene).

The electrolysis device according to the invention not only reaches an unprecedented 21% energy efficiency compared to the two other systems' efficiency not exceeding 12.2% as referenced in Table 1 below but also uses non-noble metal-based catalysts while in the two referenced cases, Ir and/or Ag was employed.

TABLE 1

| | | | | Energy efficiency |
|---|---|---|---|---|
| Device | Cathode | Anode | FY of C₂H₄ & C₂H₆ | of E-cell |
| (1) | CuAg | IrO₂ | 30% | 10.3% |
| (2) | Cu oxide | IrO₂ | 32% | 12.2% |
| (3) | DN—CuO | DN—CuO | 47% | 21% |

(1) Ager et al., Energy Environ. Sci., 2017, 10, 2222-2230
(2) Yeo et al., ACS Sustainable Chem. Eng. 2017, 5, 9191-9199;
(3) according to the invention (see the examples for the preparation of the electrodes)

In addition, the use of the same metal at both electrodes (anode and cathode) is a significant advantage as it simplifies significantly the long-term operation of the electrolyzer. Indeed, in this case, the dissolution and redeposition of metal which may occurs from the anode to the cathode will have no deleterious effect, whereas a high complex membrane set-up has to be used to avoid this risk when different metals are used at the electrodes, which impacts negatively the resistive losses of the full system.

### Definitions

For the purposes of the present invention, the term “electrolysis device”, also called “electrolyzer”, is intended to mean a device for converting electrical energy, in particular renewable electrical energy, into chemical energy.

The term “flow electrolysis device” is intended to mean an electrolysis device as defined above in which the electrolysis reaction is performed in a continuous process and not in a batch process, i.e. that anolyte and catholyte solutions are continuously flowed through the device.

By “electrode” is meant in the sense of the present invention an electronic conductor capable of capturing or releasing electrons. The electrode that releases electrons is called an “anode”. The electrode that captures electrons is called a “cathode”. Thus, an oxidation reaction occurs at the anode, whereas a reduction reaction occurs at the cathode.

By “electrolyte solution” is meant, in the present invention, a solution, preferably an aqueous solution, in which a substance is dissolved so that the solution becomes electrically conductive. This substance is named “electrolyte”. A “catholyte solution” is an “electrolyte solution” used at the cathode. A “anolyte solution” is an “electrolyte solution” used at the anode.

For the purposes of the present invention, the term “electrically conductive support” means a support capable of conducting electricity.

For the purposes of the present invention, the term “metal deposit”, is understood to mean the deposit of a metal (copper in the present invention) at the oxidation state 0. The metal deposit thus forms a metal layer on the surface of the support.

For the purposes of the present invention, the term “oxidized, sulfurated, selenated and/or tellurized form” of a metal M is understood to mean the chemical forms MₓO_{y}, MₓS_{y}, MₓSe_{y}, MₓTe_{y}, and mixtures thereof where x and y represent integers depending on the degree of oxidation of the metal M. More particularly, in the case of copper, the oxidized forms may be CuO and Cu₂O (preferably CuO), the sulfurated forms may be CuS and Cu₂S (preferably CuS), the selenated forms may be CuSe and Cu₂Se and the tellurized forms may be CuTe and Cu₂Te. Preferably it will be an oxidized and/or sulfurated form, in particular an oxidized or sulfurated form. In particular, these will be CuO or CuS forms.

The term “flow spacer” refers to a system that guides the flow of an electrolyte solution (catholyte or anolyte solution) from the inlet to the outlet of the cathodic or anodic compartment in an electrolysis device. The flow spacer allows improving this flow.

The term “(C₁-C₆)alkyl”, as used in the present invention, refers to a straight or branched monovalent saturated hydrocarbon chain containing from 1 to 6 carbon atoms including, but not limited to, methyl, ethyl, n-propyl, iso-propyl, n-butyl, iso-butyl, sec-butyl, t-butyl, n-pentyl, n-hexyl, and the like. It can be in particular a methyl or an ethyl.

The term “hydrocarbon”, as used in the present invention, refers to a linear or branched saturated or unsaturated hydrocarbon molecule. Preferably, it is a C₂ or C₃ hydrocarbon, i.e. ethane or ethylene.

The term “alcohol”, as used in the present invention, refers to a molecule of formula R—OH, wherein R represents a straight or branched monovalent saturated or unsaturated hydrocarbon chain. Preferably, it is a C₂ or C₃ alcohol, i.e. ethanol, n-propanol or isopropanol.

### DETAILED DESCRIPTION

Electrolysis Device

The electrolysis device according to the invention is an electrolysis device in which both the anode and the cathode are copper-based electrodes.

Electrode

Both the anode and the cathode of the electrolysis device according to the invention are an electrode comprising an electrically conductive support of which at least a part of the surface is covered by a metal deposit of copper, the surface of said metal deposit being in an oxidized, sulfurated, selenated and/or tellurized form and the metal deposit having a high specific surface area, and more particularly a specific surface greater than or equal to 1 m²/g.

The electrically conductive support will comprise or consist of an electrically conductive material which may be a composite material consisting of several distinct electroconductive materials. The electrically conductive material may be chosen in particular from a metal such as copper, steel, aluminum, zinc or titanium; a metal oxide such as Fluorine-doped Titanium Oxide (FTO) or Indium Tin Oxide (ITO); a metal sulphide such as cadmium sulphide or zinc sulphide; carbon in particular in the form of carbon felt, graphite, vitreous carbon, boron-doped diamond; a semiconductor such as silicon; and a mixture thereof.

This support may take any form suitable for use as an electrode, the person skilled in the art being able to determine the shape and dimensions of such a support according to the intended use.

The surface of such a support is at least partially covered by the metal deposit. Advantageously, at least 5%, in particular at least 20%, especially at least 50%, preferably at least 80%, of the surface of the support is covered by the metal deposit. According to a particular embodiment, the entire surface of the support is covered by the metal deposit.

The metal, i.e. copper, is advantageously deposited on the support by electrodeposition.

The metal deposit advantageously has a thickness of between 10 μm and 2 mm, in particular between 50 μm and 0.5 mm, preferably between 70 μm and 300 μm.

Such a thickness can be measured in particular by measuring a sample cut by Scanning Electron Microscopy (SEM), for example using a scanning electron microscope Hitachi S-4800.

The metal deposit has a high specific surface area.

The metal deposit more particularly has a specific surface area greater than or equal to 1 m²/g, in particular greater than or equal to 2 m²/g, in particular greater than or equal to 3 m²/g, for example greater than or equal to 5 m²/g or still greater than or equal to 10 m²/g. The specific surface area may be between 1 m²/g and 500 m²/g, for example between 1 m²/g and 200 m²/g, in particular between 2 m²/g and 100 m²/g, preferably between 3 m²/g and 50 m²/g, for example between 5 m²/g and 50 m²/g or between 10 m²/g and 50 m²/g. The specific surface area value is indicated per gram of metal deposit. Such a specific surface area is advantageously determined by the BET (Brunauer, Emmett and Teller) method. This BET method will advantageously be applied to a metal deposit sample obtained by mechanical abrasion using a PVC (polyvinyl chloride) blade having a thickness of 1 mm of said metal deposit present on the electrically conductive support.

The specific surface area can also be expressed in cm²/cm²_{geometric}. In this case, the specific surface area value is indicated per cm² of electrode and may advantageously be greater than or equal to 5 cm²/cm²_{geometric}, in particular greater than or equal to 10 cm cm²/cm²_{geometric}, in particular greater than or equal to 15 cm²/cm²_{geometric}. The specific surface area may be between 5 and 500 cm²/cm²_{geometric}, for example between 10 and cm²/cm²_{geometric}, in particular between 15 and 100 cm²/cm²_{geometric}, preferably between 15 and 50 cm²/cm²_{geometric}. Such a specific surface area is advantageously determined by electrochemical measurement (via the Randles-Sevcik equation), more particularly according to the following conditions. The electroactive surface of the electrode can be measured using a 1 cm² geometric surface electrode immersed in a solution containing K₃[Fe(CN)₆] 5 mM and a phosphate buffer 0.1 M, pH 7.0. The application of equation (1) then makes it possible to determine the electroactive surface value Adiff, and consequently the specific surface area determined by electrochemistry, by dividing this value by the geometrical surface of the electrode according to the relation: Specific surface area determined by electrochemistry=A_{diff}/A_{geometric} (in cm²/cm²_{geometric}). The Randles-Sevcik equation equation (1) is as follows:

iₚ=2.69×10⁵n^{3/2}D^{1/2}A_{diff}Cv^{1/2} (1)

The metal deposit will also advantageously have a porous structure.

The metal deposit will advantageously have a porosity with an average pore size of between 10 μm and 500 μm, in particular between 20 μm and 200 μm, preferably between 30 μm and 70 μm. The average pore size can be determined by means of photographs obtained by Scanning Electron Microscopy (SEM) or Scanning Tunneling Microscopy (STM), preferably by Scanning Electron Microscopy (SEM), for example using a scanning electron microscope Hitachi S-4800.

Other metals than copper may be present in this metal deposit layer, such as iron, nickel, zinc, cobalt, manganese, titanium, gold, silver, lead, ruthenium, iridium or a mixture thereof. Advantageously, these other metals will not represent more than 50% by weight, preferably not more than 30% by weight of the metal deposition layer. preferably, no other metal than copper is present.

The surface of this metal deposit (i.e. the outer surface of the metal deposit not in contact with the electrically conductive support) is in an oxidized, sulfurated, selenated and/or tellurized form, that is the metal on the surface of this metal deposit is in an oxidized, sulfurated, selenated and/or tellurized form.

According to a particular embodiment of the invention, the surface of the metal deposit is in an oxidized, sulfurated, selenated or tellurized form.

According to another particular embodiment of the invention, the surface of the metal deposit is in an oxidized and/or sulfurated form, in particular in an oxidized or sulfurated form (e.g. CuO or CuS), preferably in oxidized form (e.g. CuO).

The thickness of the oxidized, sulfurated, selenated and/or tellurized layer on the surface of the metal deposit is not critical. For example it may be between 1 nm and 1 μm, preferably between 10 and 500 nm, notably of about 250 nm.

This thickness can be measured by Transmission Electron Microscopy (TEM) of a section of the electrode made by the Focused Ion Beam (FIB) technique.

This metal deposit which is oxidized, sulfurated, selenated and/or tellurized in surface represents the catalytic system that makes it possible, in an electrolysis process, to oxidize the water to dioxygen on the anodic side and to convert CO₂ into hydrocarbons on the cathodic side.

Such an electrode is obtainable by the method detailed below.

Method to Prepare the Electrode

The electrode according to the invention can be prepared by a method comprising the following successive steps:
(i) electroplating copper on at least a portion of the surface of an electrically conductive support to form a metal deposit of copper on said at least a portion of the surface of the electrically conductive support, and
(ii) oxidation, sulfuration, selenation and/or tellurization of the surface of said metal deposit.

The electrically conductive support will be as defined above. Thus, such a support will consist, at least in part and preferably completely, of an electrically conductive material which may be a composite material consisting of several distinct electroconductive materials. The electrically conductive material may be chosen in particular from a metal such as copper, steel, aluminum, zinc or titanium; a metal oxide such as Fluorine-doped Titanium Oxide (FTO) or Indium Tin Oxide (ITO); a metal sulphide such as cadmium sulphide or zinc sulphide; carbon in particular in the form of carbon felt, graphite, vitreous carbon, boron-doped diamond; a semiconductor such as silicon; and a mixture thereof.

This support may take any form suitable for use as an electrode, the person skilled in the art being able to determine the shape and dimensions of such a support according to the intended use. The surface of such a support is at least partially covered by the metal deposit. Advantageously, at least 5%, in particular at least 20%, especially at least 50%, preferably at least 80%, of the surface of the support is covered by the metal deposition. According to a particular embodiment, the entire surface of the support is covered by the metal deposit.

This electrically conductive support will advantageously be cleaned before performing electroplating according to techniques well known to those skilled in the art.

Step (i):

The electroplating step may advantageously be carried out according to the following steps:
(a) at least partially immersing the electrically conductive support in an acidic aqueous solution containing ions of the metal to be deposited, i.e. copper, and
(b) applying a current between the electrically conductive support and a second electrode.

### Step (a):

The acidic aqueous solution containing ions of the metal to be deposited, i.e. copper, will be more particularly an acidic aqueous solution containing a salt of the metal to be deposited (also called metal salt), optionally introduced in a hydrated form. This metal salt, optionally in a hydrated form, may be any water-soluble salt of copper. It may be for example CuSO₄, CuCl₂, or Cu(ClO₄)₂; in particular CuSO₄.

The metal salt will be present in the aqueous solution advantageously at a concentration of between 0.1 mM and 10 M, in particular between 1 mM and 1 M.

It could also be envisaged to use metal complexes formed between the metal ion to be deposited and one or more organic ligands such as, for example, porphyrins, amino acids or amines, to introduce the metal ions into the aqueous solution.

The acid introduced into the acidic aqueous solution may be any acid, whether organic or inorganic. It may be for example sulfuric acid, hydrochloric acid, hydrobromic acid, formic acid or acetic acid, especially sulfuric acid. Preferably, it will not be nitric acid. This acid may be present in the acidic aqueous solution advantageously at a concentration of between 0.1 mM and 10 M, in particular between 10 mM and 3 M.

The acidic aqueous solution is advantageously prepared using deionized water to better control the ionic composition of the solution.

The electrically conductive support will be totally or partially immersed in the acidic aqueous solution containing the ions of the metal to be deposited, depending on whether a deposit over the entire surface or only of a part of the surface of the support is desired.

In order to obtain a deposit on only a portion of the surface of the support, it may also be envisaged to apply a mask consisting of an insulating material on the parts of the support which must not be covered by the metal deposit. In this case, the complete support, on which the mask has been applied, may be immersed in the acidic aqueous solution containing the ions of the metal to be deposited. This mask will be removed from the support after deposition of the metal.

### Step (b):

In this step, the electrically conductive support will act as a cathode, while the second electrode will play the role of anode.

The second electrode will advantageously be immersed in the acidic aqueous solution containing the ions of the metal to be deposited but may also be immersed in another electrolyte solution electrically connected to the acidic aqueous solution. The use of a single electrolyte solution, namely the acidic aqueous solution containing the ions of the metal to be deposited, remains preferred.

The nature of the second electrode is not critical. It is just necessary for performing the electroplating by an electrolysis process. It may be for example a platinum or titanium electrode.

The current applied between the electrically conductive support and the second electrode may be alternating or direct. It will advantageously be direct and will preferably have a high current density of between 0.1 mA/cm² and 5 A/cm², in particular between 0.1 mA/cm² and 1 mA/cm². Alternatively, a voltage for generating an equivalent current density may be applied between the electrodes.

When applying the current, two reduction reactions will take place at the cathode:

on the one hand the reduction of metal ions to metal of oxidation state 0 according to the following reaction with M representing the metal, i.e. copper, and x representing its initial degree of oxidation:

M^{x+}+xe⁻→M
on the other hand the reduction of protons into dihydrogen according to the following reaction:

2H⁺+2e⁻→H₂

Similarly, an oxidation reaction will take place at the anode during the application of the current. The nature of this oxidation reaction is not crucial. It may be for example the oxidation of water.

The electroplating thus allows the deposition on the surface of the electrically conductive support of a thin layer of metal with a high specific surface, the growth of the metal on the surface of the electrically conductive support being made in a dendritic manner. In addition, the formation of hydrogen bubbles on the surface of the electrically conductive support, thanks to the proton reduction reaction, also makes it possible to confer a porous structure to this metal deposit layer, thus making it possible to further increase its specific surface area. The choice of the current density will make it possible in particular to optimize the size and the number of bubbles formed so as to obtain the desired structure and specific surface area for the metal deposit.

The current will also be applied for a time sufficient to obtain the desired amount of deposit, in particular to obtain a thickness of said metal deposit layer of between 10 μm and 2 mm, in particular between 50 μm and 0.5 mm, preferably between 70 μm and 300 μm. For example, the current may be applied for a period of between 1 and 3600 s, for example between 15 and 1200 s, in particular between 30 and 300 s.

The duration of application and the current density may be adapted according to the chosen reaction conditions such as the nature and concentration of the metal ions, the concentration of acid, etc. to obtain the desired metal deposit, especially with the desired specific surface area and thickness.

The electroplating will be advantageously carried out by a galvanostatic method, that is to say by applying a constant current throughout the duration of the deposit.

Once the current is applied, the electrically conductive support of which at least a portion of the surface is covered by a metal deposit may be removed from the solution in which it was immersed. It must be cleaned, especially with water (e.g. distilled water), before being dried, especially under vacuum or under an inert gas flow (argon, nitrogen, helium, etc.).

Step (ii):

Once the metal deposited on at least a portion of the surface of the electrically conductive support, the outer surface of the metal deposit will be oxidized, sulfurated, selenated and/or tellurized.

The oxidation step will advantageously be carried out in an atmosphere containing oxygen (e.g. air) or in the presence of H₂O, preferably in an atmosphere containing oxygen (e.g. air). The sulfuration step will advantageously be carried out in the presence of elemental sulfur or of H₂S, preferably in the presence of elemental sulfur. The selenation step will advantageously be carried out in the presence of elemental selenium or of H₂Se, preferably in the presence of elemental selenium. The tellurization step will advantageously be carried out in the presence of elemental tellurium or H₂Te, preferably in the presence of elemental tellurium.

This oxidation, sulfuration, selenation and/or tellurization step will advantageously be carried out at an elevated temperature, in particular at a temperature of between 30 and 700° C., in particular between 50 and 500° C., in particular between 100 and 400° C.

An annealing step may be carried out following the oxidation, sulfuration, selenation and/or tellurization step. This annealing step will advantageously be carried out at a temperature of between 50° C. and 1000° C., in particular between 100° C. and 400° C. This annealing step will be carried out advantageously under an inert gas atmosphere (Ar, N₂, He, etc.) or under vacuum. This annealing step will be carried out advantageously for a sufficiently long period, in particular for a time of between 10 minutes and 48 hours, in particular between 1 and 3 hours.

A high specific surface area is maintained after this oxidation, sulfuration, selenation and/or tellurization step and optionally annealing step.

Step (iii):

An additional step of deposition of metal oxide on the surface of the metal deposit may optionally be carried out after step (ii). This will thus make it possible to have an additional layer of metal oxide on the surface of the metal deposit.

The metal oxide will be a copper oxide, and more particularly CuO.

This metal oxide deposit may advantageously be performed according to the following steps:
(1) immersing at least the portion of the electrically conductive support covered with a metal deposit whose external surface is oxidized, sulfurated, selenated and/or tellurized obtained in step (ii) in a solution containing ions of the metal of the metal oxide to be deposited (i.e. copper ions) and advantageously water, and
(2) applying an electric potential between the electrically conductive support and a second electrode, the electric potential applied to the electrically conductive support being negative and then positive.

### Step (1):

The solution containing the ions of the metal of the metal oxide to be deposited will be more particularly a solution containing a metal salt of the metal oxide to be deposited (i.e. copper salt), optionally introduced in a hydrated form. This metal salt, optionally in a hydrated form, may be any copper salt. For example, it may be CuSO₄, CuCl₂ or Cu(ClO₄)₂ or a mixture thereof.

It could also be envisaged to use metal complexes formed between the metal ion of the metal oxide to be deposited and one or more organic ligands such as, for example, porphyrins, amino acids or amines (e.g. imidazole, 1,4,8,11-tetraazacyclotetradecane (cyclam) or 1,4,8,11-tetramethyl-1,4,8,11-tetraazacyclotetradecane (Me4-cyclam), to introduce the metal ions into the solution. In particular it may be CuCl₂ complexed with one or more, in particular 1 or 2, organic ligands, preferably nitrogen-based organic ligands, such as amines, which may be in particular Cu(imidazole)₂Cl₂, Cu(cyclam)Cl₂ or Cu(Me₄-cyclam)Cl₂, and preferably Cu(imidazole)₂Cl₂.

The metal salt will be present in the solution advantageously at a concentration of between 0.1 mM and 10 M, in particular between 1 mM and 0.1 M.

The solution containing metal ions of the metal oxide to be deposited may be a solution in water and/or an organic solvent, especially in water or in a water/organic solvent mixture. The solvent used (water and/or organic solvent) will be selected so as to solubilize the metal salt. The organic solvent may be any suitable solvent such as acetonitrile, pyridine, tetrahydrofuran (THF), dimethylsulfoxide (DMSO) or dimethylformamide (DMF), especially acetonitrile. The water used will preferably be deionized water to better control the ionic composition of the solution.

The solution may also contain a salt that cannot be oxidized or reduced and therefore does not participate in the oxidation-reduction reaction but which allows conducting an electrical current. The nature of this salt is therefore not critical. It should be chosen so that it is soluble in the solvent used (water and/or organic solvent). It may be TBAPF₆ (tetrabutylammonium hexafluorophosphate) or TBABF₄ (tetrabutylammonium tetrafluoroborate).

The electrically conductive support will be totally or partially immersed in the solution containing the metal ions of the metal oxide to be deposited according to the surface of the support to be covered.

### Step (2):

This deposition step by cyclic voltammetry comprises two phases, namely:
the application of a current ramp between the electrically conductive support and a second electrode towards a negative electrical potential applied to the electrically conductive support: this phase allows the electrodeposition of metal on the surface of the metal deposit obtained at step (ii), the electrically conductive support then acting as a cathode and the second electrode playing the role of anode; then
the application of a current ramp between the electrically conductive support and a second electrode to a positive electrical potential applied to the electrically conductive support: this phase allows the oxidation of the deposited metal on the surface of the metal deposit obtained at step (ii), the electrically conductive support then acting as an anode and the second electrode acting as a cathode.

This step (2) comprising the two aforementioned phases may be repeated once or more so as to optimize the deposition of metal oxide and the performance of the electrode obtained. Advantageously, step (2) is carried out 1 or 2 times, in particular 2 times.

The second electrode will advantageously be immersed in the solution containing the metal ions of the metal oxide to be deposited but may also be immersed in another electrolyte solution electrically connected to the solution containing the metal ions of the metal oxide to be deposited. The use of a single electrolyte solution, namely the solution containing the metal ions of the metal oxide to be deposited and water, remains preferred.

The nature of the second electrode is not critical. It is just necessary for performing the electrodeposition and then the oxidation. It may be for example a platinum or titanium electrode.

When applying the current with a negative potential applied to the electrically conductive support, a reduction reaction will take place at the cathode (electrically conductive support), namely the reduction of the metal ions to metal of oxidation degree 0 according to the following reaction with M representing the metal (i.e. copper) and x representing its initial oxidation state:

M^{x+}+xe⁻→M.

Similarly, an oxidation reaction will take place at the anode during the application of the current. The nature of this oxidation reaction is not crucial. It may be for example the oxidation of water.

This phase thus allows the electrodeposition of a thin layer of metal on the surface of the metal deposit obtained in step (ii).

When applying the current with a positive potential applied to the electroconductive medium in the presence of a source of oxygen (which may be water, hydroxide ions, oxygen or another source of oxygen, preferably water), an oxidation reaction will take place at the anode (electrically conductive support), namely the oxidation of the metal, for example according to the following reaction in the case of water as a source of oxygen with M representing the metal (i.e. copper) and x representing its degree of oxidation:

M+H₂O→MO+2e⁻+2H⁺.

Similarly, a reduction reaction will occur at the cathode during the application of the current. The nature of this reduction reaction is not crucial. It could be for example the reduction of water

2H₂O+2e⁻→H₂+2OH⁻

This phase thus allows the oxidation of the thin layer of electrodeposited metal on the surface of the metal deposit obtained in step (ii).

This step (2) may advantageously be carried out by one or more, in particular 1 or 2, cycles of cyclic voltammetry, that is to say by application of a current linearly varying in time.

Once the metal oxide deposited, the electrically conductive support can be removed from the solution in which it was immersed. It must be cleaned, especially with water (e.g. distilled water), before being dried, especially under vacuum or under an inert gas flow (argon, nitrogen, helium, etc.).

Electrolysis Cell

The electrolysis device according to the invention comprises an anode and a cathode as defined above.

According to one embodiment, the electrolysis device will comprise also an anodic compartment and a cathodic compartment, advantageously separated by a membrane. The use of a membrane between the anodic and cathodic compartments allows for an easy separation of the reaction products formed in each compartment which are mainly gases.

Preferably the electrolysis device will be a flow electrolysis device.

The distance between the anode and the cathode (interelectrode distance) of the electrolysis device according to the invention advantageously is comprised between 15 and 0.1 cm, preferably between 2 and 0.1 cm. The use of a lower interelectrode distance allows reducing the overall cell resistance.

The membrane separating the anodic compartment and the cathodic compartment can be an anion exchange membrane (AEM), a cation exchange membrane (CEM) or a bipolar membrane, preferably an anion exchange membrane.

The anion exchange membrane will be useful in particular for the circulation of CO₃²⁻ anion. It can be notably a Selemion™ AEM.

The cation exchange membrane can be in particular a proton exchange membrane (PEM) useful for the circulation of H⁺ cation. It can be a Nafion® membrane. Nafion® is a copolymer of tetrafluoroethylene (Teflon®) and perfluoro-3,6-dioxa-4-methyl-7-octene-sulfonic acid.

The bipolar membrane is a layered ion exchange membrane comprising a first layer which is permeable to the anions and a second layer which is permeable to the cations.

When the electrolysis device is a flow electrolysis device, the anodic compartment and the cathodic compartment will each comprise an inlet and an outlet in order to allow the circulation of an anolyte solution through the anodic compartment and a catholyte solution through the cathodic compartment respectively.

The anodic compartment and the cathodic compartment can then each comprise a flow spacer linked to the inlet and to the outlet of the anodic or cathodic compartment respectively. The flow spacer allows an efficient flow of the electrolyte solution.

The flow spacer comprises an internal cavity connected to the inlet and the outlet and being in direct contact with the electrode (cathode or anode) and the membrane. Since gases are generated both in the anodic compartment (dioxygen) and in the cathodic compartment (hydrocarbons such as ethane or ethene), the form of the internal cavity of the flow spacer should be designed so as to allow an efficient evacuation of the gas bubbles generated during electrolysis. Advantageously, it will have a convex form such as a trapezoid (e.g. a parallelogram, such as a rhombus), an hexagon or an ellipse (e.g. with a high eccentricity), preferably with its thinner part positioned upward.

The flow spacer can be made in any chemically inert and electrically insulating material, for example a polymer such as PTFE (polytetrafluoroethylene—Teflon®), a polyurethane (PU), polypropylene (PP), a polyamide (PA), polyether ether ketone (PEEK) and the like or a ceramic such as alumina, aluminosilicate and the like.

To improve the tightness of the electrolysis device, sealing rings can be added respectively between the flow spacer and the membrane and between the flow spacer and the electrode (anode or cathode). It can be more particularly a sealing O-ring.

The sealing ring can be made in any chemically inert material, such as PTFE (polytetrafluoroethylene—Teflon®), a silicon, a fluoropolymer elastomer such as Viton®.

A preferred electrolysis device according to the invention is based on a two-compartment flow electrolysis device containing an anion-exchange membrane between the anodic and cathodic compartments. A well-defined area of each working electrode (anode and cathode) will be exposed to the circulating electrolyte solution (anolyte and catholyte solutions respectively) thanks to the presence of a flow spacer (notably in PTFE). The spacers comprise an internal cavity having advantageously a trapezoidal or hexagonal shape to avoid bubbles' accumulation and resulting instability issues. The spacers can be connected to a peristatic pump allowing the thorough control of the flowing speed of the electrolyte solutions. The tightness of the set-up can be ensured by a series of sealing rings (e.g. silicon-based sealing O-rings) and by its embedment in a rigid frame (preferentially metallic). This electrolysis device allows for a very short interelectrode distance for minimal resistance while allowing simple products separation. Such a preferred electrolysis device according to the invention is illustrated on FIG. 1.

The electrolysis device according to the invention will advantageously comprise a system to collect the gases formed in each electrolysis compartment. Thus a first collector system can be connected to the outlet of the cathodic compartment to collect the gases produced in this compartment, and in particular the hydrocarbons such as ethane or ethene. A second collector system can be connected to the outlet of the anodic compartment to collect the gas produced in this compartment, i.e. dioxygen. These collector systems also allow continuously evacuating and collecting the reaction products.

Source of Electrical Energy

The electrolysis device can be coupled to a source of electrical energy, such as a source of renewable electricity, which can be in particular an intermittent source of renewable energy such as a photovoltaic panel or a wind turbine.

However, any other source of electrical energy can be used.

Method for Converting CO₂ into Hydrocarbons

The electrolysis device according to the invention can be used in a method for reducing carbon dioxide (CO₂) into hydrocarbons (e.g. ethane, ethene, propylene, propane). Such a method comprises the following steps:

a) providing an electrolysis device according to the invention;
b) exposing the cathode of said electrolysis device to a CO₂-containing aqueous catholyte solution;
c) exposing the anode of said electrolysis device to an aqueous anolyte solution; and
d) applying an electrical current between the anode and the cathode in order to reduce the carbon dioxide into hydrocarbons.

Step a)

The electrolysis device used in the method according to the invention can be an electrolysis device as detailed above. It can be in particular a flow electrolysis device.

Step b)

The catholyte solution is a CO₂-containing aqueous catholyte solution.

Preferably, the aqueous solution is saturated with CO₂, notably by bubbling the CO₂ gas directly into the solution.

Advantageously, the catholyte solution comprises a salt of hydrogen carbonate (HCO₃⁻), such as an alkali metal salt or a quaternary ammonium salt of hydrogen carbonate. The alkali metal can be potassium, sodium or cesium, preferably cesium. The quaternary ammonium can have the formula NR₁R₂R₃R₄⁺ wherein R₁, R₂, R₃ and R₄, identical or different, preferably identical, are a (C₁-C₆)alkyl, such as methyl or ethyl. The quaternary ammonium can be in particular a tetramethylammonium or a tetraethylammonium. Preferably the salt of hydrogen carbonate is CsHCO₃. It should be noted that the continuous CO₂ bubbling in the catholyte solution allows regenerating the diffused bicarbonate anions.

The concentration of the salt of hydrogen carbonate advantageously is below 1M, notably below 0.5M. It can be comprised between 0.01M and 0.5M, notably between 0.5M and 0.2M. For example, it can be about 0.1M.

The catholyte solution is advantageously prepared using deionized water to better control the ionic composition of the solution.

Step c)

The anolyte solution is an aqueous anolyte solution.

Advantageously, the anolyte solution comprises a salt of carbonate (CO₃²⁻), such as an alkali metal salt or a quaternary ammonium salt of hydrogen carbonate. The alkali metal can be potassium, sodium or cesium, preferably cesium. The quaternary ammonium can be as defined above and have the formula NR₁R₂R₃R₄⁺ wherein R₁, R₂, R₃ and R₄, identical or different, preferably identical, are a (C₁-C₆)alkyl, such as methyl or ethyl. The quaternary ammonium can be in particular a tetramethylammonium or a tetraethylammonium. Preferably the salt of carbonate is Cs₂CO₃.

The concentration of the salt of carbonate advantageously is below 1M, notably below 0.5M. It can be comprised between 0.01M and 0.5M, notably between 0.5M and 0.2M. For example, it can be about 0.1M.

The anolyte solution is advantageously prepared using deionized water to better control the ionic composition of the solution.

The use of carbonate-based electrolyte solutions in both anodic and cathodic compartments provides high efficiency and stability to the electrolysis method. The presence of an anion exchange membrane allowing the circulation of CO₃²⁻ anions is then preferred to avoid their accumulation on the membrane and consequent clogging, so that a continuous operation of the system at high current densities is possible.

Step d)

An electrical current is applied between the anode and the cathode in order to reduce the carbon dioxide into hydrocarbons, such as ethane, ethylene, propane propylene and the like. During this reduction step, other valuable reduction products can be formed such as alcohols (e.g. ethanol, propan-1-ol and isopropanol).

The electrical current applied advantageously has a potential difference (voltage) comprised between 10 and 1.5 V, preferably between 5 and 1.5 V.

When the electrical current is applied, reduction reactions occur at the anode and reduction reaction occurs at the cathode.

At the cathode, reduction reactions of CO₂ occur according to the following reaction and lead to the formation of hydrocarbons and alcohols, preferably in C₂ or C₃:

xCO₂+(4x−2z−y)H⁺+(4x−2z−y)e⁻→CₓH_{y}O_{z}+(2x−z)H₂O

At the anode, an oxidation of water occurs according to the following reaction and leads to the formation of dioxygen and protons:

2H₂O→O₂+4H⁺+4e⁻

The use of an electrolysis device according to the invention allows obtaining a faradic yield (FY) above 30%, preferably above 50%.

The electrolysis device according to the invention allows the conversion of CO₂ to hydrocarbons at current densities as high as 25 mA·cm⁻² obtained at a cell potential below 3 V, ensuring high efficiencies.

The present invention is illustrated by the following non-limitative examples and figures.

### LEGENDS OF THE FIGURES

FIG. 1: Schematic electrolyzer cell according to the invention with:

(1) anion exchange membrane (e.g. thickness: 0.2 mm)

(2) sealing O-ring (e.g. fiberglass reinforced silicone, thickness: 0.2 mm)

(3) flowing spacer (e.g. PTFE, thickness: 3 mm)

(4) anode

(5) cathode

(6) electrode area (cathode or anode) (e.g. about 1 cm²)

(a) interelectrode distance (e.g. 7 mm)

R.E. Reference electrode

the arrows representing the flows of the electrolyte solutions.

This electrolyzer cell has been used in all the examples, except otherwise mentioned, with the features indicated in parenthesis.

FIG. 2: a) Linear sweep voltammetry (LSV) of DN—CuO cathode (light grey) and DN-CuO anode (black), using a scan rate of 10 mV·s⁻¹ (currents are uncorrected for resistive losses incurred within the electrolyte, all current densities are based on projected geometric area). b) J-E curve of the electrolyzer cell using DN—CuO electrodes. c) Faradaic efficiencies for CO₂ reduction products using DN—CuO cathode at different potentials. All measurements were carried out using the electrolyzer cell described in the examples below and illustrated on FIG. 1 using an anion exchange membrane separating the cathodic (CO₂ saturated 0.1 M CsHCO₃) and anodic (0.2 M Cs₂CO₃) compartments. Constant CO₂ saturation was ensured by constant sparging of the cathodic electrolyte with CO₂ at 2.5 mL·min⁻¹.

FIG. 3: a) LSV of DN—CuO electrode for CO₂ reduction in 0.1M NaHCO₃ at different flow rates of electrolyte. b) Total faradaic efficiency (FE) of ethylene and ethane at −0.95V vs RHE (reversible hydrogen electrode) at different flow rates of electrolyte.

FIG. 4: a) J-E curve of the electrolyzer cell using DN—CuO electrodes as both cathode and anode in different electrolytes: (black-solid line) cathodic solution—CO₂ saturated 0.1 M NaHCO₃ and anodic solution—0.2 M Na₂CO₃, (black-dash line) cathodic solution —CO₂ saturated 0.1 M KHCO₃ and anodic solution—0.2 M K₂CO₃, (light grey-solid line) cathodic solution—CO₂ saturated 0.1 M CsHCO₃ and anodic solution—0.2 M Cs₂CO₃. b) FE of ethylene and ethane when cations are Na⁺ and Cs⁺.

FIG. 5: a) Long-term (3 h) electrolysis for splitting CO₂ using flow cell with DN—CuO electrode as both cathode and anode and b) corresponding Faradaic efficiency for C₂H₄+C₂H₆ during 3 h CO₂ reduction electrolysis.

FIG. 6: a) Comparison of cell potentials (E_{cell}) as a function of current density between the flow electrochemical cell (solid line) and a H-type electrochemical cell (dash line). In both setup DN—CuO electrodes were employed as both cathode and anode, using a solution of CO₂-saturated 0.1 M CsHCO₃ (pH 6.8) as catholyte, a solution of 0.2 M Cs₂CO₃ (pH 11) as anolyte, separated by a Selemion AEM. b) Faradaic efficiencies of CO₂ reduction in 0.1 M CsHCO₃-saturated CO₂ using DN—CuO in H-type electrochemical cell.

FIG. 7: a) Current vs. cell voltage obtained in the flow cell: (light grey) DN—CuO was used as both cathode and anode, (black) Cu oxide plate electrode was used as both cathode and anode electrode. b) Faradaic efficiency of CO₂ reduction using Cu oxide plate electrode.

FIG. 8: a) Current-potential characteristic of the perovskite mini-module under 1 sun, AM1.5G illumination (squares) and measured operating current of the electrolyzer cell (geometric areas of cathode=0.35 cm² and anode=0.85 cm², current measured after 5 min electrolysis) at various potentials (dots). b) Electrolyzer cell current as a function of photoelectrolysis time using the perovskite mini-module as the sole energy source.

FIG. 9: Faradaic efficiencies for CO₂ reduction products using crystalline Cu dendrites electrode in electrolyzer cell using DN—CuO as anode (comparative example).

### EXAMPLES

### General Considerations

Electrocatalytic measurements and electrolysis experiments in the flow electrochemical cell were carried out using a Bio-logic SP300 potentiostat. H₂ and gaseous CO₂ reduction products were analyzed by gas chromatography (GC) (SRI Instruments), Multi-Gas Analyzer #5 equipped with a HayeSep® D column and MoleSieve 5A column, thermal Conductivity Detector (TCD) and Flame Ionization Detector (FID) with methanizer using Argon as a carrier gas. GC was calibrated by using a standard gas mixture containing 2500 ppm of H₂, CO, CH₄, C₂H₄, C₂H₆, C₃H₆, C₃H₈, C₄H₈ and C₄H₁₀ in CO₂ (Messer). The liquid phase products were quantified using Ionic chromatography and Nuclear Magnetic Resonance (NMR) spectroscopy. Formate and oxalate were analyzed by ionic exchange chromatography (883 Basic IC, Metrohm). Ethanol was analyzed by ¹H NMR spectroscopy using a Bruker AVANCE III 300 spectrometer. SEM images were acquired using a Hitachi S-4800 scanning electron microscope. TEM images were obtained on a JEM-2010F transmission electron microscope (JEOL) with an accelerating voltage of 200 kV.

The most relevant criteria to evaluate the performance of the electrical to chemical energy conversion device is the energy efficiency (EE). The thermoneutral potential (Eₜₕ) must then be introduced so that thermal losses are taken into account into the calculations avoiding any energy efficiency overestimation. The calculations are detailed below in the particular cases of ethane (C₂H₆) and ethene (C₂H₄), which are the targeted products herein.

2CO₂+2H₂O→C₂H₄+3O₂ (2)

ΔH(C₂H₄)=−2ΔH(CO_{2 (aq)})−2ΔH(H₂O)+3ΔH(O₂)=1600.41 kJ·mol⁻¹ (3)

2CO₂+3H₂O→C₂H₆+7/2O₂ (4)

ΔH(C₂H₆)=−2ΔH(CO_{2(aq)})−2ΔH(H₂O)+7/2ΔH(O₂)=1451.52 kJ·mol⁻¹ (5)

Eₜₕ=ΔH/n (n is the number of electron) (6)

EE(C₂H₄+C₂H₆)=(FY(C₂H₄)×Eₜₕ(C₂H₄)+FY(C₂H₆)×Eₜₕ(C₂H₆))/Ucell (7)

ΔH=standard enthalpy of reaction; FY=faradaic yield of the catalytic reaction

### General Preparation of the Electrolyser

Preparation of the electrodes

Electrodes were prepared as described in Angew. Chem. Int. Ed. 56, 4792 (2017) and are named DN—CuO (dendritic nanostructured copper oxide material) in the following sections.
Flow electrochemical cell

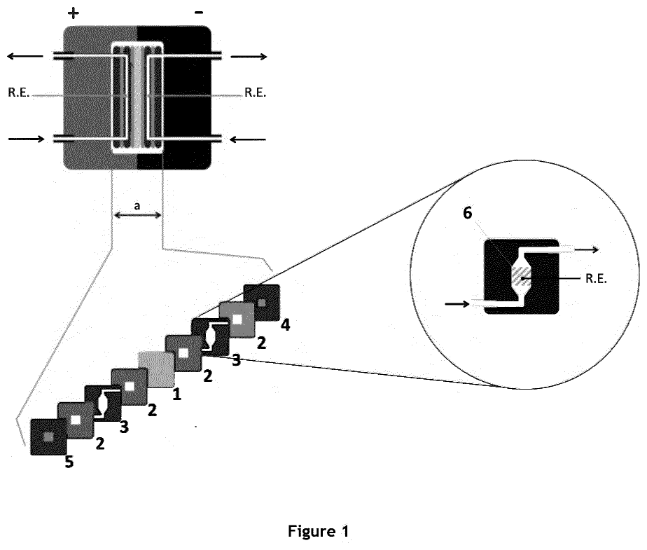

The scheme of the flow electrochemical cell is presented in FIG. 1. The distance between cathode and anode is 0.7 cm. A Selemion™ AEM (Anion Exchange Membrane) separates the cathodic and anodic compartments. Each half-cell comprises, in sequence, the electrode, a 0.2 mm-thick sealing O-ring made from fiberglass-reinforced silicone, a 3 mm PTFE (polytetrafluoroethylene) flowing spacer and another O-ring before the membrane. The geometrical surface area of the working electrodes was chosen to be 1 cm² for all this study, unless otherwise specified. The PTFE spacers were designed using a trapezoidal shape for the electrolyte inlet/outlet and the connection with the tubing. Ag wire was used as pseudo-reference electrode and placed in both compartments and was calibrated with an aqueous Ag/AgCl reference electrode before each experiment. The electrode potentials were referred to RHE according to the following formula:

E(vs RHE)=E(vs Ag wire)+ΔE+0.2+0.059×pH

where the potential difference (ΔE) between the Ag wire and the Ag/AgCl electrode was determined using the E_{1/2} potential of K₃Fe(CN)₆ in 0.1M CsHCO₃ solution as a reference. Unless otherwise stated, catalytic activity was investigated in this setup using 0.1 M CsHCO₃ saturated with CO₂ (pH 6.8) at the cathode and 0.2 M Cs₂CO₃ (pH 11.0) at the anode, flowed through the two compartments at a constant flow of 1.0 mL·min⁻¹.

### Example 1: Electrical to Chemical Energy Conversion According to the Invention

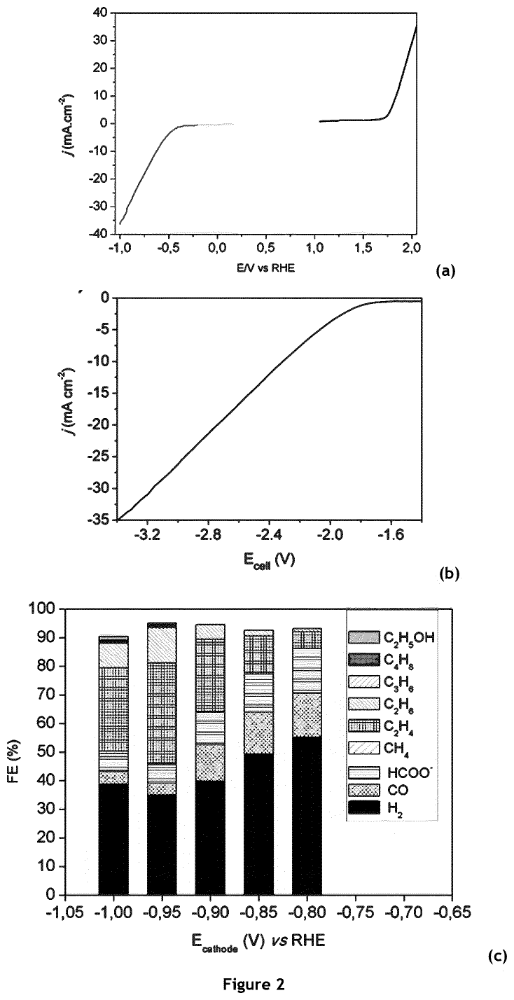

The catalytic activity of a full electrochemical cell comprising two identical 1 cm² DN—CuO electrodes for cathode and anode, a CO₂-saturated 0.1 M CsHCO₃ aqueous solution in the cathodic compartment and a 0.2 M Cs₂CO₃ aqueous solution in the anodic compartment flowing at 1 mL·min⁻¹ was assessed. A stable current density of 25 mA·cm⁻² at a cell potential of 2.95 V was obtained leading to an energy efficiency conversion of CO₂ towards ethene and ethane equal to 21%. The detail of the reduction products' faradaic yield is displayed in FIG. 2. Among the CO₂ reduction products, C₂H₄ accounted for 37% FY, C₂H₆ for 12.8% FY, HCOOH for 7% FY and CO for 5%.

### Example 2: Influence of the Electrolyte Flow Rate

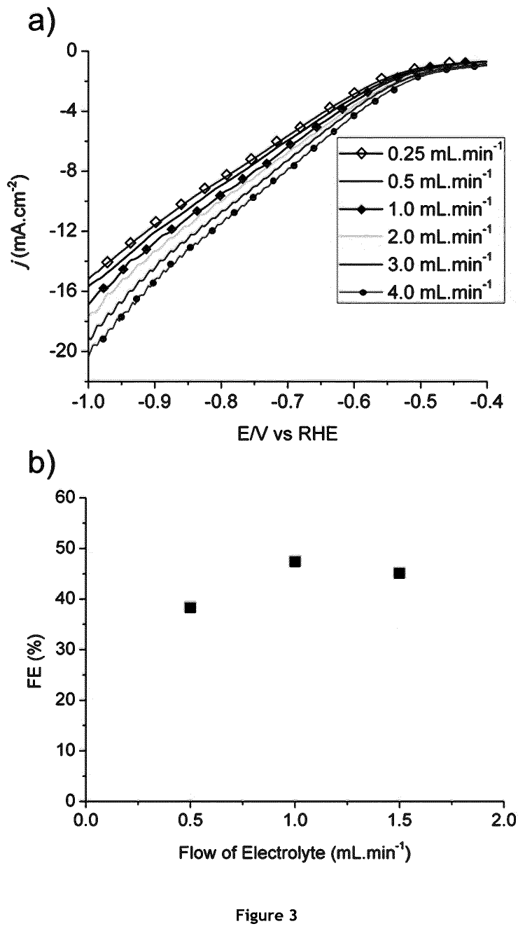

The influence of the electrolyte flow rate was tested, maintaining all other operating conditions described in Example 1. Increasing the electrolyte flow led to an increase of the cathodic activity of the DN—CuO as shown by linear sweep voltammetry studies (LSVs, FIG. 3): at −1.0 V vs. RHE, −20 mA·cm⁻² were reached using a CO₂ flow of 4 mL·min⁻¹, in comparison with −15.5 mA·cm⁻² at 0.25 mL·min⁻¹.

The FE selectivity of CO₂ reduction to hydrocarbons was also varied at different electrolyte flow rates. The highest FE of ethylene and ethane was obtained at the flow rates of 1.0 mL·min⁻¹ and justifies the choice of this flow rate in further studies (FIG. 3.b).

### Example 3: Influence of the Carbonate-Based Electrolyte Cation

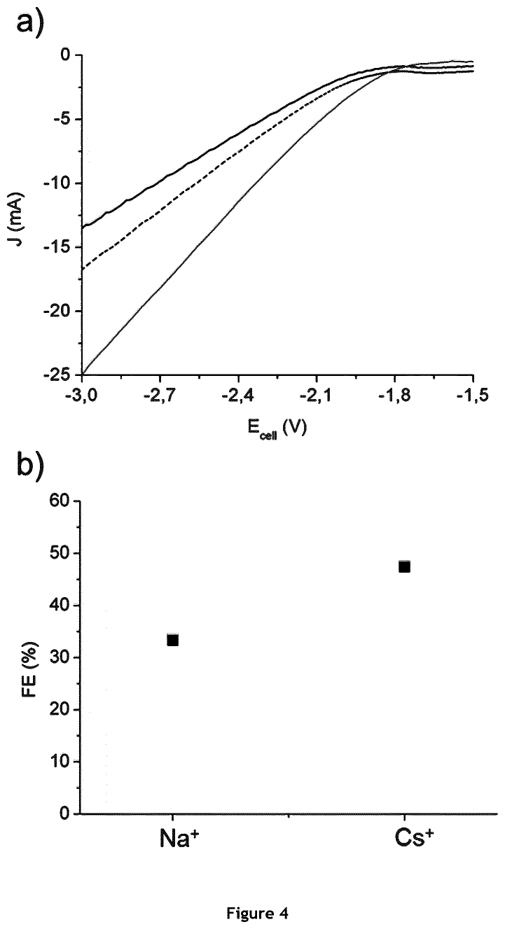

The influence of the carbonate-based electrolyte cation “X+” was tested, maintaining all other operating conditions described in Example 1 (FIG. 4). In each case, 0.1 M XHCO₃ was used along with 0.2 M X₂CO₃ as the catholyte and anolyte respectively. At 3.0 V cell potential, −25 mA·cm⁻² were reached using Cs⁺ as a cation, in comparison with −17 mA·cm⁻² and −13 mA·cm⁻² using K⁺ and Na⁺ respectively. The FE selectivity of CO₂ reduction to hydrocarbons was also varied depending on the cation. The highest FE of 47% for ethylene and ethane was obtained using Cs⁺ in comparison with 33% using Na⁺ for instance and justifies the choice of this cation in further studies (FIG. 4.b).

### Example 4: Long-Run Operation of the System

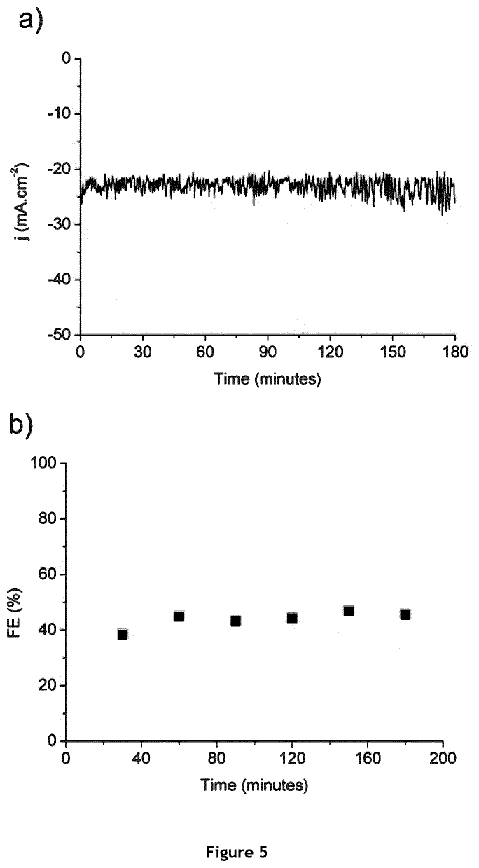

Stability of the system was investigated over a 3 h period in the flow cell maintaining all other operating conditions described in Example 1. Stable current density of 22 mA·cm⁻² was observed along with a stable total FY of 47% for ethane and ethene (FIG. 5) preserving an energy efficiency of 21%.

### Example 5: Advantages of the Invention Compared to an Electrochemical H-Cell Set-Up

The electrodes of the present invention were tested in a H-type electrolyzer maintaining all other operating conditions described in Example 1. The H-cell set-up is used in the literature (Nature Catalysis 2018, 1, 421-428) for catalytic performances testing, made of two glass half-cells separated by a defined membrane (anion exchange membrane) with an interelectrode distance of 6 cm.

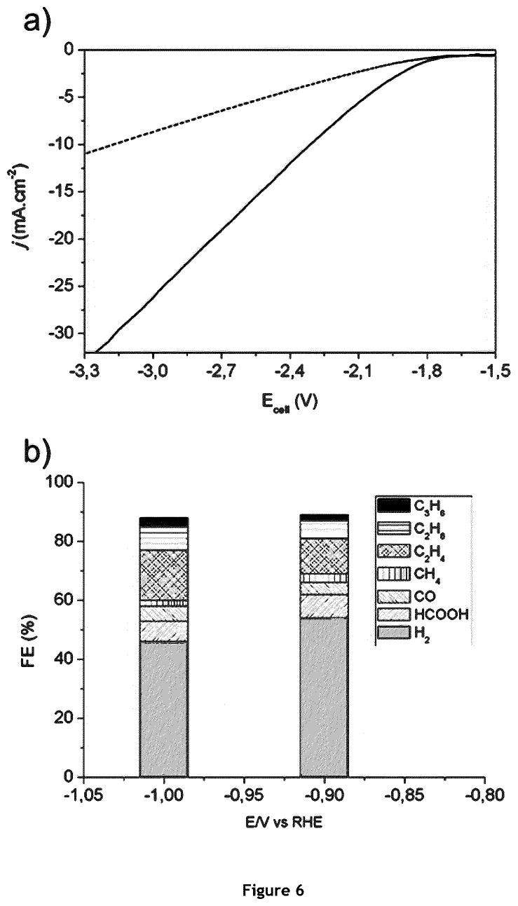

To obtain a stable current of 25 mA·cm⁻², 4.8 V was needed in such a H-type electrolyzer. This should be compared with the electrolyzer of the present invention, for which a cell potential of only 2.95 V was sufficient to reach this current (FIG. 6). Using the H-type set-up, lower faradaic efficiencies were reached (˜25% total FY for ethene and ethane) at about −0.90 V vs. RHE compared to the 50% obtained at −0.95 V vs. RHE obtained in the flow conditions. The resulting energy efficiency for ethylene and ethane using this H-cell set-up is only 5.4%, which is significantly lower than when using the flow cell of the present invention (49.8%).

### Example 6: Advantage of the Invention Compared to Non-Nanostructured Electrodes

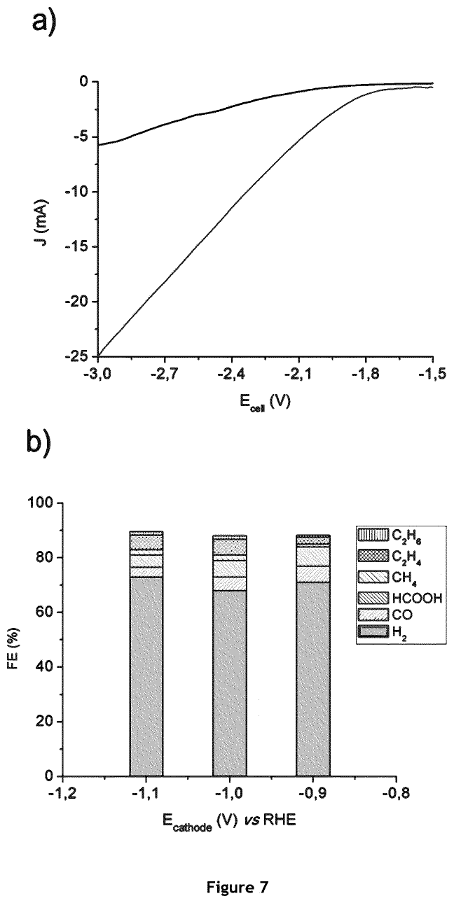

The electrolyzer of the present invention was tested using non-nanostructured Cu-based electrodes while maintaining all other operating conditions described in Example 1. These Cu oxide plate electrodes were fabricated by annealing flat Cu foil (1.0 cm²) under air condition at 300° C. for 30 min before depositing a Cu oxide nanoparticle layer (following DN—CuO synthesis). These steps are the equivalent of steps (ii) and (iii) described above and have been performed in the same conditions as for preparing DN—CuO in example 1 (using Cu(imidazole)₄Cl₂ as copper precursor in step (iii)). At a cell potential of 3.0 V, only 6.0 mA was reached (FIG. 7) in comparison with the 25 mA obtained using the synergetic combination of electrolyzer and DN—CuO electrodes according to the present invention. As such, the energy efficiency for ethylene and ethane formation with non-nanostructured electrodes is only 1.3% in comparison with the record 21% presented in the reported invention.

### Example 7: Engineering of a Fully Integrated Solar-to-Fuel Conversion Device

The electrolysis cell (EC) according to the invention was coupled with high performing perovskite photovoltaic cell (PV) (Science, 2016, 360, 6392) mini-module made of two series of three perovskite solar cells connected in parallel as an electrical power source. The full PV-EC system demonstrated a 2.3% solar-to-hydrocarbons (η_{S-H}) efficiency calculated as follows:

η_{S-H}=η_{S-E}×EE(C₂H₄+C₂H₆)

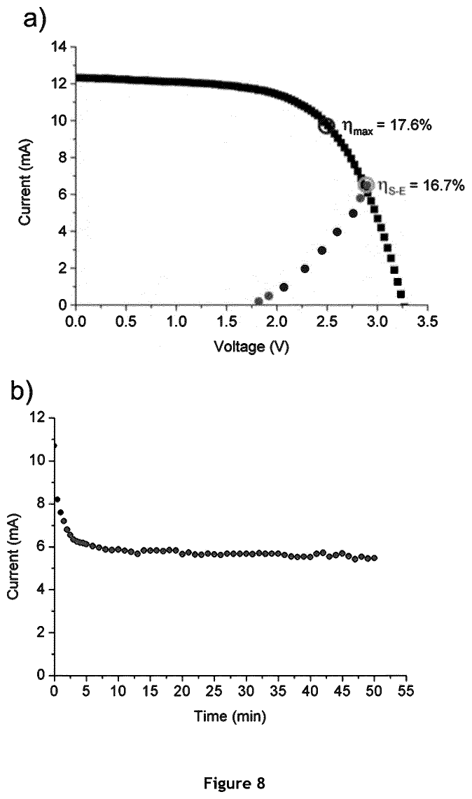

with η_{S-E} being the solar-to-electricity efficiency of the perovskite mini-module obtained experimentally as displayed in FIG. 8.

This performance sets a new benchmark for an inexpensive all earth-abundant PV-EC system.

### Comparative Example 8

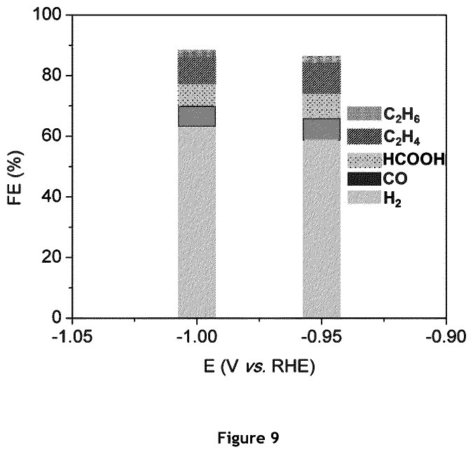

A 1 cm² dendritic Cu electrode free of copper oxide surface was prepared by immersing 1 cm² of a freshly cleaned Cu plate in a 0.2 M CuSO₄, 1.5 M H₂SO₄ solution (20 ml) and applying a current of −0.5 A using a galvanostatic method for a duration of 80 s, followed by a rinsing with copious amounts of distilled water before being dried in air at room temperature. The catalytic activity of a full electrochemical cell comprising such a 1 cm² dendritic Cu electrode and a 1 cm² DN—CuO electrode for anode, a CO₂-saturated 0.1 M CsHCO₃ aqueous solution in the cathodic compartment and a 0.2 M Cs₂CO₃ aqueous solution in the anodic compartment flowing at 1 mL·min⁻¹ was assessed. A stable current density of 21 mA·cm⁻² at a cell potential of 2.9 V was obtained leading to an energy efficiency conversion of CO₂ towards ethene and ethane equal to 6.5%. The detail of the reduction products' faradaic yield is displayed on FIG. 9. Among the CO₂ reduction products, C₂H₄ accounted for 11% FY, C₂H₆ for 3.6% FY, HCOOH for 8% FY and CO for 6.5%.

1. An electrolysis device comprising an anode and a cathode,
wherein the anode and the cathode each are an electrode comprising an electrically conductive support of which at least a part of the surface is covered by a metal deposit of copper,
wherein the metal deposit may comprise other metals than copper selected from iron, nickel, zinc, cobalt, manganese, titanium, gold, silver, lead, ruthenium, iridium and a mixture thereof, said other metals representing no more than 50% by weight of the metal deposit,
wherein the surface of the metal deposit is in an oxidized form and the metal deposit has a specific surface area greater than or equal to 1 m²/g, the specific surface area being determined by the Brunauer, Emmett and Teller (BET) method.

2. The electrolysis device according to claim 1, wherein said other metals represent no more than 30% by weight of the metal deposit.

3. The electrolysis device according to claim 1, wherein the electrically conductive support comprises an electrically conductive material selected from a metal; a metal oxide; a metal sulphide; carbon; a semiconductor; and a mixture thereof.

4. The electrolysis device according to claim 1, wherein the metal deposit is dendritic.

5. The electrolysis device according to claim 1, wherein the metal deposit has a thickness comprised between 10 μm and 2 mm.

6. The electrolysis device according to claim 1, wherein the metal deposit has a specific surface area comprised between 1 m²/g and 500 m²/g.

7. The electrolysis device according to claim 1, wherein the metal deposit has a porous structure with an average pore size of between 10 μm and 500 μm, the average pore size being determined by means of photographs obtained by Scanning Electron Microscopy (SEM).

8. The electrolysis device according to claim 1, wherein the distance between the anode and the cathode is comprised between 15 and 0.1 cm.

9. The electrolysis device according to claim 1, comprising an anodic compartment and a cathodic compartment separated by a membrane.

10. The electrolysis device according to claim 9, wherein the anodic compartment and the cathodic compartment each comprise an inlet and an outlet intended to allow the circulation of an anolyte solution through the anodic compartment and a catholyte solution through the cathodic compartment respectively.

11. The electrolysis device according to claim 10, wherein the anodic compartment and the cathodic compartment each comprise a flow spacer linked to the inlet and to the outlet of the anodic or cathodic compartment respectively, the flow spacer being a system that guides the flow of the anolyte or catholyte solution from the inlet to the outlet of the anodic or cathodic compartment respectively.

12. The electrolysis device according to claim 11, wherein the flow spacer is separated from the anode or the cathode and from the membrane by a sealing ring.

13. The electrolysis device according to claim 1, coupled to a source of an electrical energy.

14. A method for reducing carbon dioxide (CO₂) into hydrocarbons comprising the following steps:
a) providing an electrolysis device according to claim 1;
b) exposing the cathode of said electrolysis device to a CO₂-containing aqueous catholyte solution;
c) exposing the anode of said electrolysis device to an aqueous anolyte solution; and
d) applying an electrical current between the anode and the cathode in order to reduce the carbon dioxide into hydrocarbons.

15. The method according to claim 14, wherein the catholyte solution comprises a salt of hydrogen carbonate, and
wherein the anolyte solution comprises a salt of carbonate.

16. The method according to claim 14, wherein the electrical current applied between the anode and the cathode has a potential difference comprised between 10 and 1.5 V.

17. The electrolysis device according to claim 3, wherein the metal is copper, steel, aluminum, zinc or titanium; the metal oxide is Fluorine-doped Titanium Oxide (FTO) or Indium Tin Oxide (ITO); the metal sulphide is cadmium sulphide or zinc sulphide; the carbon is in the form of carbon felt, graphite, vitreous carbon, or boron-doped diamond; the semiconductor is silicon.

18. The electrolysis device according to claim 1, wherein the metal deposit has a specific surface area comprised between between 3 m²/g and 50 m²/g; a porous structure with an average pore size of between 30 μm and 70 μm, the average pore size being determined by means of photographs obtained by Scanning Electron Microscopy (SEM); and a thickness comprised between 70 μm and 300 μm.

19. The electrolysis device according to claim 9, wherein the membrane is an anion exchange membrane.

20. The electrolysis device according to claim 13, wherein the electrical energy is a photovoltaic panel or a wind turbine.

21. The method according to claim 15, wherein the salt of hydrogen carbonate is an alkali metal salt or a quaternary ammonium salt of hydrogen carbonate, and
the salt of carbonate is an alkali metal salt or a quaternary ammonium salt of carbonate.
